(19) United States
(12) Patent Application Publication
(10) Pub. No.: US 2009/0283208 A1
(43) Pub. Date: Nov. 19, 2009

(54) Method for Manufacturing Sheets

(76) Inventor: Chien-Ying LIU, Taipei City (TW)

Correspondence Address: Troxell Law Office Pllc, Suite 1404, 5205 Leesburg Pike, Falls Church, VA, 22041, US

(21) Appl. No.: 12/122,999

(22) Filed: May 19, 2008

(51) Int. Cl. B29C 70/02

(52) U.S. Cl. 156/245

(57) ABSTRACT

A method for manufacturing sheets includes first setting up a mold and then followed by conducting steps for making the sheets. As stone is thin-plate stone, the sheet is light-weighted, allowing a user to easily install the sheet to a desired location and achieving an object of saving installation time and cost of labor hours. Furthermore, an inner layer of the sheet is provided with a thermal insulating material, to achieve objects of thermal insulation and saving electricity. On the other hand, as the stone can be assembled by putting together waste stone, an object of recycling for environmental protection is achieved.

### BACKGROUND OF THE INVENTION

a) Field of the Invention

The present invention relates to a method for manufacturing sheets, and more particularly to a manufacturing method wherein a mold is set up first, followed by proceeding with steps for manufacturing the sheets, with materials and the steps for manufacturing the sheets including stone) adhesive agents, sho fiber concretes) fiber webs, short fiber concretes, thermal insulating materials, sho fiber concretes, fiber webs and sho fiber concretes, so as to form the sheets into products when the concretes are dr and set, thereby accomplishing the manufacturing of sheets.

b) Description of the Prior Art

As conventional ordinary stone is too thick and heavy, if a dry implementation method, which is one of the implementation methods of the stone) including the dry and wet methods, is employed, then a large amount of iron pieces should be used to fix the stone on a wall. In addition, a water seepage phenomenon will easily appear many years after the dry implementation. On the other hand, if the wet implementation method is to be applied, then the stone will not be easily adhered on an outer wall, and the method cannot be used in a tall building or a large and heavy surface material due to that the stone is too thick and heavy. Accordingly, it will be inconvenient to implement, cost and labor hours will be wasted, and restrictions to implementation will be too many that also troubles users. Furthermore, after accomplishing the implementation to the stone, some stone will be left over which cannot be recycled, thereby wasting the stone and cost without having a spirit of environmental protection.

### SUMMARY OF THE INVENTION

The primary object of the present invention is to provide a method for manufacturing sheets, wherein a mold is set up first, followed by proceeding with steps for manufacturing the sheets, with materials and the steps for manufacturing the sheets including stone, adhesive agents, short fiber concretes, fiber webs, short fiber concretes, thermal insulating materials, short fiber concretes, fiber webs and short fiber concretes, so as to form the sheets into products when the concretes are dry and set, thereby accomplishing the manufacturing of sheets. As the stone used is thin plate of stone, the sheets will be light-weighted, allowing a user to install the sheets to desired locations easily and achieving an object of saving installation time and cost of labor hours. Moreover as an inner layer of the sheet is provided with the thermal insulating material, the sheet can be insulated from heat to save electricity. On the other hand, as the stone can be assembled by putting together waste stone, an object of recycling for environmental protection is achieved.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system block diagram of the present invention.

FIG. 2 shows a first block diagram of an implementation of the present invention.

FIG. 3 shows a second block diagram of an implementation of the present invention.

FIG. 4 shows a three dimensional view of the present invention.

FIG. 5 shows a perspective view of the present invention.

FIG. 6 shows a cutaway view of the present invention.

FIG. 7 shows a first schematic view of an embodiment of the present invention.

FIG. 8 shows a second schematic view of an embodiment of the present invention.

FIG. 9 shows a third schematic view of an embodiment of the present invention.

FIG. 10 shows a fourth schematic view of an embodiment of the present invention.

### DETAILED DESCRIPTION OF THE PREFERRED EMBODIMENTS

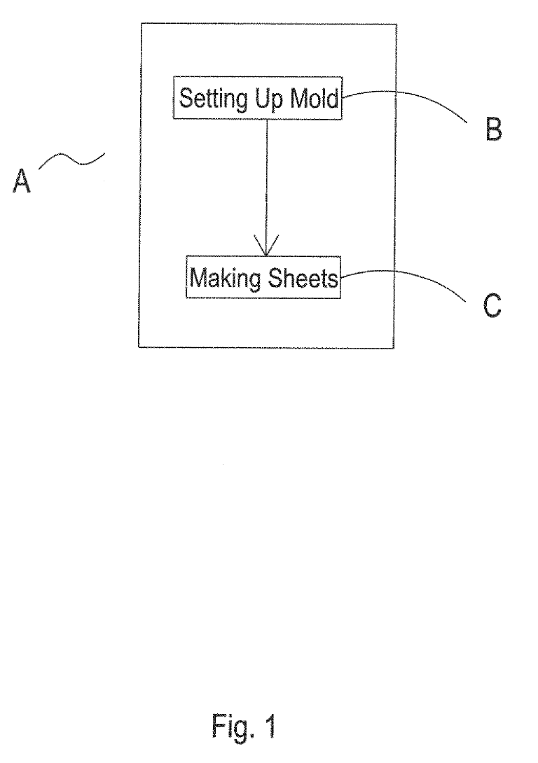

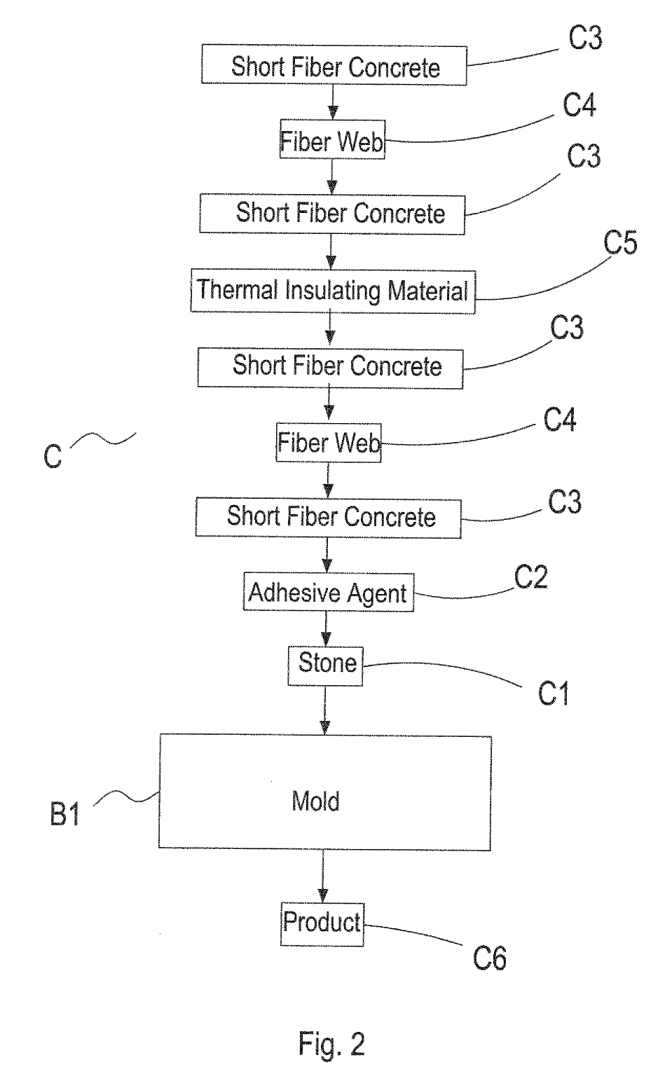

Referring to FIGS. 1 and 2, a manufacturing flow of sheets A includes setting up a mold B and making the sheets C. After accomplishing the set up of mold 8 in the manufacturing flow of sheets A, steps for making the sheets C are carried out.

Materials and the steps for making the sheets C of the manufacturing flow of sheets A are that placing stone C1 in a mold B1; filling the stone C1 with an adhesive agent C2; adding a short fiber concrete C3 on the stone C1 which is filled with the adhesive agent C2; placing a fiber web C4; filling the mold B8 with the short fiber concrete C3; placing a thermal insulating material C5; filling with the sho fiber concrete C3; placing the fiber web C4; and filling with the short fiber concrete C3, sequentially. After the short fiber concretes C3 are dry and set, a product of the sheet C6 is formed, thereby accomplishing the steps for making the sheets C.

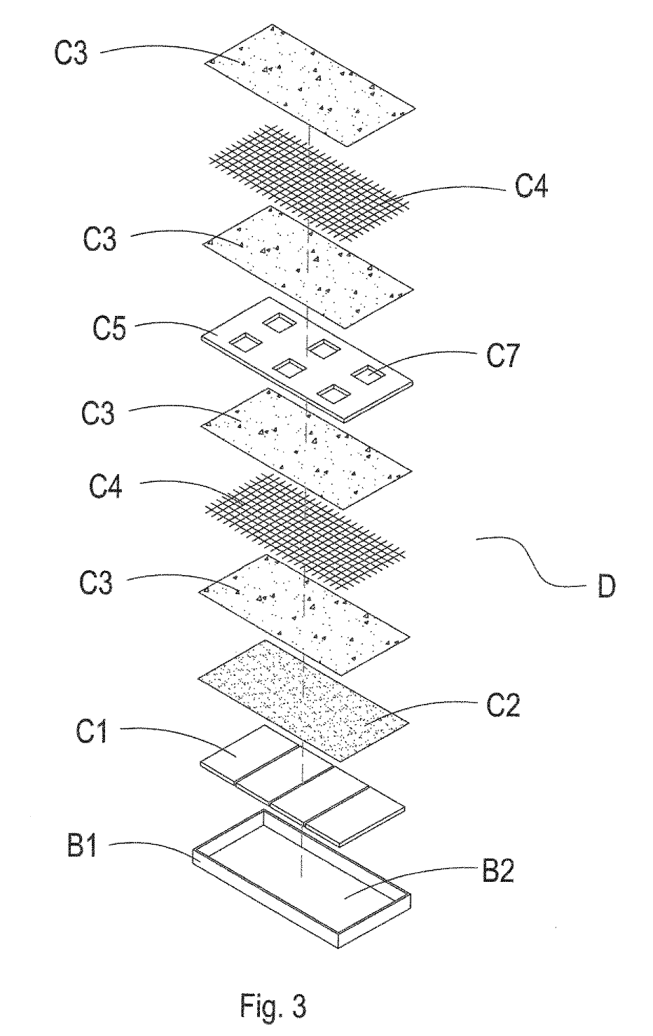

Referring to FIG. 1 and FIG. 3, the manufacturing flow of sheets A of the present invention includes setting up the mold B and making the sheets C, wherein the mold B1 is provided with a hollow slot B2, and after setting up the mold B, the steps of making the sheets C of the manufacturing flow of sheets A are conducted.

Referring to FIGS. 1 to 3, it shows a system block diagrams a first block diagram of an implementation, and a second block diagram of an implementation of the present invention. The materials and the steps for making the sheets C of the manufacturing flow of sheets A are that placing stone C1 into the slot B2; filling with the adhesive agent C2; filling the mold BA with the sho fiber concrete C3; placing the fiber web C4 and then filling with the short fiber concrete C3; placing the thermal insulating material C5 into the slot B2 of the mold B1, with plural holes C7 of the thermal insulating material C0 allowing the short fiber concrete C3 to flow to the other side of the thermal insulating material C5 for filling gaps so as to intensity a fixing of structures; filling with the short fiber concrete C3; placing the fiber web C4; and filling the slot B2 of mold B1 with the short fiber concrete C3, orderly. After the sho fiber concretes C3 are dry and set, the product of the sheet C6 is formed, thereby accomplishing the manufacturing of a sheet D.

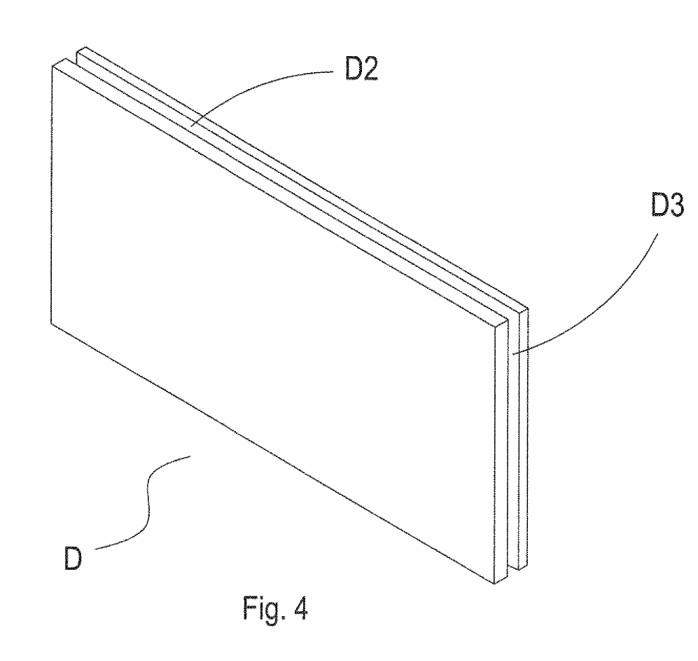

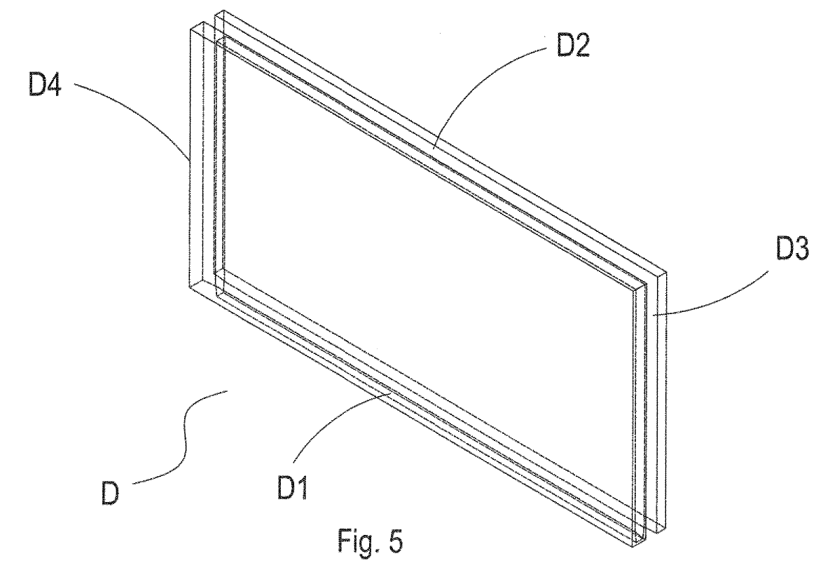

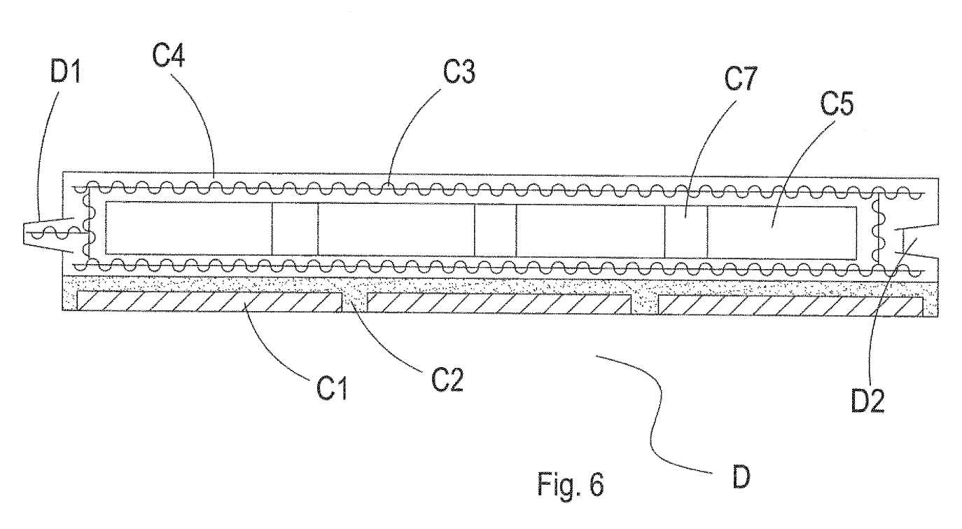

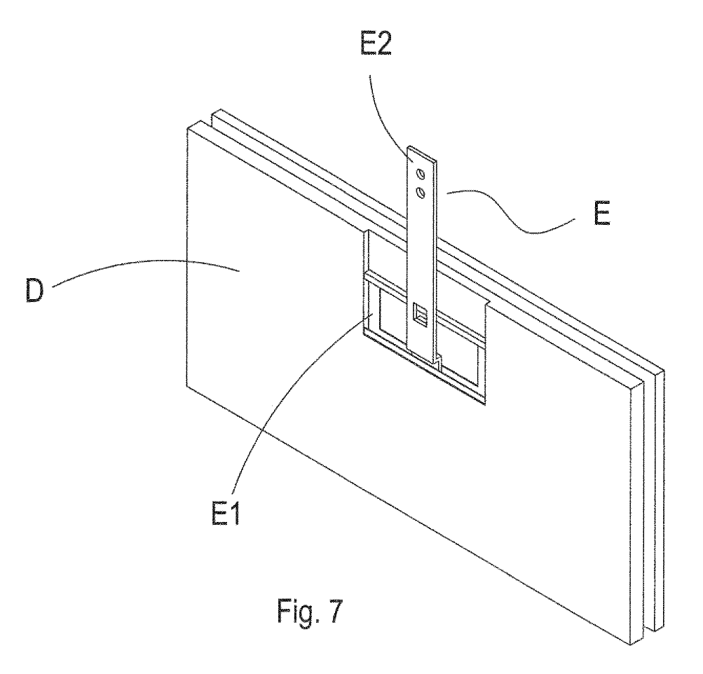

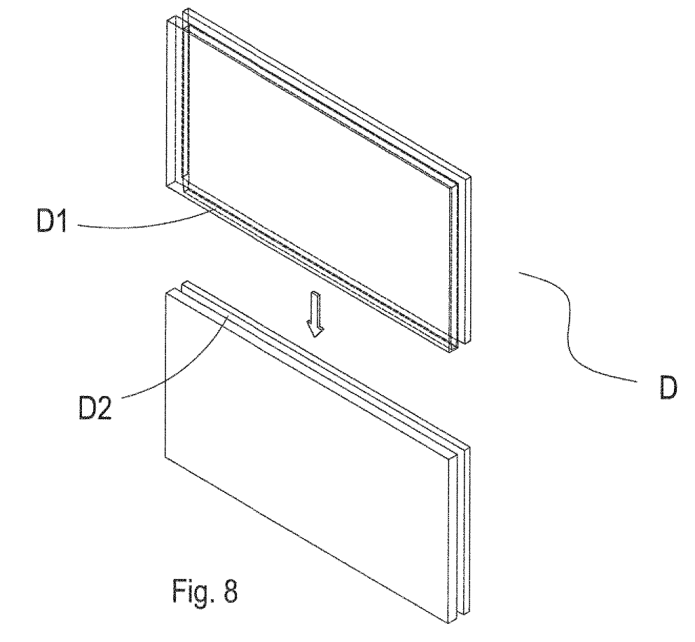

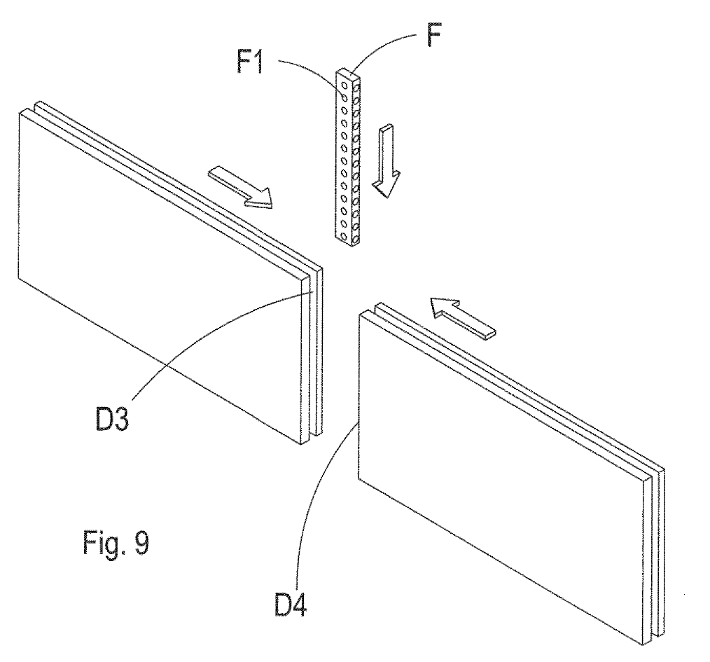

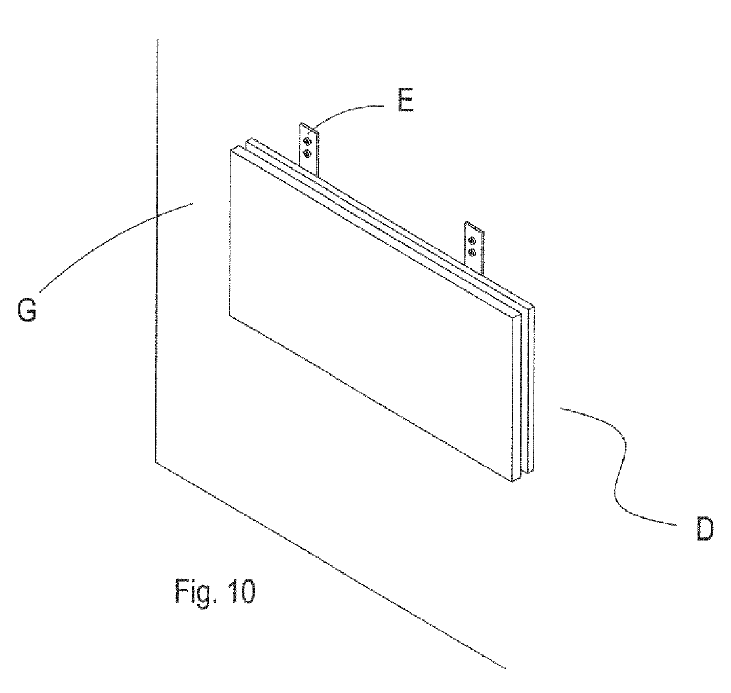

Referring to FIGS. 4 to 10, the sheet D is latched with a fixing device E, such that when the sheet D is to be latched on a wall G, the sheet D can be latched on by a fixing piece E2 of the fixing device E and a location of the sheet D can be adjusted freely by collaboration of a slide piece E1 and the fixing piece E2 of the fixing device E, thereby facilitating a user to implement. In addition, a side of the sheet D is provided with a protruded rib D1, and the other side is provided respectively with a first groove D2, a second groove D3 and a third to groove D4. If the sheet D is to be assembled with the other sheet D from two sides, then the assembling can be carried out just by making the protruded rib D1 of the sheet D to be opposed to and latched with the first groove D2 of the other sheet D. On the other hand, when the sheet D is joined together with the other sheet D from the other two sides, the joining can be conducted just by making the second groove D3 of the sheet D to be opposed to the third groove D4 of the other sheet D, followed by placing a plate F, which is provided with a plurality of holes F1 in a holding space formed between the sheet D and the other sheet D, and filling into the holes F1 with glue, so as to accomplish an object of fixing when the glue is set in the holes F1.

The stone C1 is a thin-plate stone C1 to be light-weighted, and the stone C1 can be further a glass or tile that can be decorated. In addition, the adhesive agent C2 can be cement or other adhesive agent C2 that can be adhered, the short fiber concrete C3 can be a zirconium oxide anti-base short fiber concrete or cement that can be fixed, and the fiber web C4 can be a zirconium oxide anti-base fiber web. Moreover, the thermal insulating material C5 can be ploylone or rock wool that is provided with a thermal insulating effect.

Accordingly, as the sheet D is light-weighted, the user can easily install the sheet D on a desired location and an object of saving installation time and cost of labor hours can be achieved. In addition, as an inner layer of the sheet D is provided with the thermal insulating material C5, an object of thermal insulation and saving electricity can be achieved. On the other hand, as the stone C1 can be assembled by putting together the waste stone C1, an object of recycling for environmental protection can be achieved. Moreover, as the material used for assembling the sheet D is cement and does not contain resin, a material quality of the sheet D will not be changed indoors or outdoors; therefore, no toxic gas will be formed when the sheet D is burning in fire.

To further manifest the advancement and practicability of the present invention, advantages of the present invention are listed below:
1. The stone is the thin-plate stone, which enables the sheet to be light-weighted,
2. According to item 1, the user can easily install the sheet to the desired location, so as to save the installation time and the cost of labor hours.
3. The inner layer of the sheet is provided with the thermal insulating material, to achieve the thermal insulating effect.
4. According to item 3, the object of saving electricity is achieved.
5. The stone can be assembled by putting together the waste stone, so as to achieve the object of recycling for environmental protection.
6. The material used for assembling the stone is cement,
7. According to item 6, the material quality of the sheet will not be changed indoors or outdoors; therefore, no toxic gas will be formed when the sheet is burning in fire,
8. It is provided with the business competitiveness.
9. It is provided with the value of business utilization.
10. It is provided with the novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method for manufacturing sheets, wherein a manufacturing flow of the sheets comprises first setting up a mold followed by conducting steps for making the sheets, so as to latch the sheet to a desired location by a fixing device after manufacturing; the steps for making the sheets including first putting stone into the mold; filling with an adhesive agent; adding a short fiber concrete; placing a fiber web; filling the mold with a short fiber concrete; placing a thermal insulating material in the mold, filling with the short fiber concrete; filling with the fiber web; and filling the mold with the short fiber concrete, so as to form a product of the sheet when the short fiber concrete are dry and set, thereby accomplishing the manufacturing of the sheets; accordingly due to that the sheet is light-weighted, a user being easily install the sheet to a desired location, thereby achieving an object of saving installation time and cost of labor hours; as an inner layer of the sheet is provided with the thermal insulating material, the sheet being insulated from heat and electricity being saved; the stone being assembled by putting together waste stone, thereby achieving an object of recycling for environmental protection.

2. The method for manufacturing sheets according to claim 1, wherein the stone is thin-plate stone, enabling the stone to be light-weighted, with the stone being further a glass or tile that is decorated.

3. The method for manufacturing sheets according to claim 1 wherein the adhesive agent is cement or other adhesive agent that is adhered.

4. The method for manufacturing sheets according to claim 1, wherein the thermal insulating material is provided with a plurality of holes by which the concrete flows to the other side of the thermal insulating material to fill gaps, thereby intensifying a fixing of structures.

5. The method for manufacturing sheets according to claim 1, wherein the thermal insulating material is polylone or rock wool that is provided with a thermal insulating effect.

6. The method for manufacturing sheets according to claim 1, wherein the fiber web is an zirconium oxide fiber web or a ceramic fiber web.

7. The method for manufacturing sheets according to claim 1, wherein the concrete is a zirconium oxide shoe fiber concrete, a zirconium oxide anti-base fiber web or a cement concrete that is fixed.

8. The method for manufacturing sheets according to claim 1, wherein the sheet is latched with a fixing device, such that when the sheet is latched on a wall, the sheet is latched by the fixing device, with a location of the sheet being adjusted freely by collaboration of a slide piece and a fixing piece of the fixing device.

9. The method for manufacturing sheets according to claim 8, wherein a side of the sheet is provided with a protruded rib, and the other side is provided respectively with a first groove, a second groove and a third groove, such that when the sheet is to be assembled with the other sheet, the assembling is conducted just by making the protruded rib of the sheet to be opposed to and latched with the first groove of the other sheet.

10. The method for manufacturing sheets according to claim 9, wherein when the sheet is joined together with the other sheet from two sides, the joining is accomplished by making the second groove of the sheet to be opposed to the third groove of the other sheet, followed by placing a plate in a holding space formed between the sheet and the other sheet, and filling with glue, so as to accomplish an object of fixing.
